(19) United States
(12) Patent Application Publication
(10) Pub. No.: US 2024/0168161 A1
(43) Pub. Date: May 23, 2024

(54) RANGING DEVICE, SIGNAL PROCESSING METHOD THEREOF, AND RANGING SYSTEM

(71) Applicant: Sony Group Corporation, Tokyo (JP)

(72) Inventors: Yusuke MORIUCHI, Kanagawa (JP); Motonobu FUJIOKA, Kanagawa (JP); Kenichiro NAKAMURA, Saitama (JP); Takayuki SASAKI, Tokyo (JP)

(73) Assignee: Sony Group Corporation, Tokyo (JP)

(21) Appl. No.: 18/282,428

(22) PCT Filed: Jan. 25, 2022
(86) PCT No.: PCT/JP2022/002509

§ 371 Date: Sep. 15, 2023

(30) Foreign Application Priority Data
Mar. 31, 2021 (JP) 2021-059289

(51) Int. Cl. G01S 17/42; G01S 7/48; G01S 7/4863; G01S 7/497; G01S 17/894

(52) U.S. Cl. CPC G01S 17/42; G01S 7/4808; G01S 7/4863; G01S 7/497; G01S 17/894

(57) ABSTRACT

There is provided a ranging device, a signal processing method thereof, and a ranging system capable of more accurately outputting an acquisition coordinate position of distance information. The ranging device includes a pixel array in which pixels are arranged in a matrix, a record unit that records the number of detected photons for each division unit obtained by dividing a sample point including a plurality of pixels into predetermined division units, and a correction unit that corrects a representative position of spatial coordinates of distance information of the sample point on the basis of the number of detected photons for each of a plurality of division units. The present technology can be applied to, for example, a ranging system and the like that measures a distance to an object by a direct ToF method.

### TECHNICAL FIELD

The present technology relates to a ranging device, a signal processing method thereof, and a ranging system, and especially relates to a ranging device, a signal processing method thereof, and a ranging system capable of more accurately outputting an acquisition coordinate position of distance information.

### BACKGROUND ART

A ToF sensor of a direct ToF method (hereinafter, also referred to as a dToF sensor) detects reflected light, which is pulse light reflected by an object, using a light receiving element referred to as a single photon avalanche diode (SPAD) in each pixel for light reception. In order to reduce noise caused by ambient light or the like, the dToF sensor repeats emission of the pulse light and reception of the reflected light thereof a predetermined number of times (for example, several to several hundred times) to generate a histogram of time of flight of the pulse light, and calculates a distance to the object from the time of flight corresponding to a peak of the histogram.

Since operation circuits such as a histogram generation unit that generates the histogram, a peak detection unit that detects the peak of the histogram and the like have large circuit scale, so that it is currently difficult to provide them for all the pixels.

Furthermore, it is known that an SN ratio is low and it is difficult to detect a peak position in ranging of a low-reflectivity or distant subject, ranging in an environment where external light has a strong influence of disturbance such as an outdoor environment and the like. Therefore, by allowing the emitted pulse light to have a spot shape, a reach distance of the pulse light is expanded, in other words, the number of detection of the reflected light is increased. Since the spot-shaped pulse light is generally sparse pulse light, pixels that detect the reflected light are also sparse according to a spot diameter and an irradiation area.

In view of the above, for the purpose of improving the SN ratio and reducing power by efficient pixel driving in accordance with a sparse reflected light detection environment, only some pixels of a pixel array are allowed to perform a light reception operation as active pixels, a plurality of adjacent pixels (referred to as a multipixel) is regarded as one large pixel, and the histogram is generated in multipixel unit.

For example, Patent Document 1 discloses a method of increasing the SN ratio instead of lowering the spatial resolution by forming the multipixel using any number of adjacent pixels such as two by three, three by three, three by six, three by nine, six by three, six by six, and nine by nine, creating a histogram using signals of the formed multipixel, and performing ranging.

Non-Patent Document 1 discloses a relationship between a baseline direction and an epipolar line in epipolar geometry.

### CITATION LIST

### Patent Document

Patent Document 1: Japanese Patent Application Laid-Open No. 2020-112443

### Non-Patent Documents

Non-Patent Document 1: Zhengyou Zhang, Determining the Epipolar Geometry and its Uncertainty: A Review, RR-2927, INRIA, 1996, ffinria-00073771f, “https://hal.inria.fr/inria-00073771/file/RR-2927.pdf”

### SUMMARY OF THE INVENTION

### Problems to be Solved by the Invention

For example, a predetermined representative position such as coordinates of a center pixel of a multipixel is set as acquisition position coordinates of distance information calculated in the multipixel. However, there has been a case where the acquisition position coordinates as the representative position are not necessarily accurate, and adaptation to an application requiring a high resolution of spatial coordinates is difficult.

The present technology has been achieved to solve such circumstance, and an object thereof is to output the acquisition coordinate position of the distance information with higher accuracy.

### Solutions to Problems

A ranging device according to a first aspect of the present technology includes a pixel array in which pixels are arranged in a matrix, a record unit that records the number of detected photons for each division unit obtained by dividing a sample point including a plurality of the pixels into predetermined division units, and a correction unit that corrects a representative position of spatial coordinates of distance information of the sample point on the basis of the number of detected photons for each of a plurality of the division units.

In a signal processing method of a ranging device according to a second aspect of the present technology, a ranging device including a pixel array in which pixels are arranged in a matrix records the number of detected photons for each division unit obtained by dividing a sample point including a plurality of the pixels into predetermined division units, and corrects a representative position of spatial coordinates of distance information of the sample point on the basis of the number of detected photons for each of a plurality of the division units.

A ranging system according to a third aspect of the present technology includes an illumination device that applies pulse light, and a ranging device that receives reflected light, which is the pulse light reflected by an object, in which the ranging device includes a pixel array in which pixels that receive the reflected light are arranged in a matrix, a record unit that records the number of detected photons for each division unit obtained by dividing a sample point including a plurality of the pixels into predetermined division units, and a correction unit that corrects a representative position of spatial coordinates of distance information of the sample point on the basis of the number of detected photons for each of a plurality of the division units.

In the first to third aspects of the present technology, the number of detected photons for each division unit obtained by dividing a sample point including a plurality of the pixels of a pixel array in which the pixels are arranged in a matrix into predetermined division units is recorded, and a representative position of spatial coordinates of distance information of the sample point is corrected on the basis of the number of detected photons for each of a plurality of the division units.

A ranging device and a ranging system may be independent devices or modules incorporated in another device.

### BRIEF DESCRIPTION OF DRAWINGS

FIG. 1 is a block diagram illustrating a configuration example of a ranging system of the present disclosure.

FIG. 2 is a diagram for explaining a problem handled by the ranging system of the present disclosure.

FIG. 3 is a diagram for explaining first correction processing performed by a ranging device of the present disclosure.

FIG. 4 is a diagram for explaining second correction processing performed by the ranging device of the present disclosure.

FIG. 5 is a block diagram illustrating a detailed configuration example of a first embodiment of the ranging system.

FIG. 6 is a diagram for explaining correction processing of spatial coordinates in the first embodiment.

FIG. 7 is a flowchart for explaining first ranging processing by the first embodiment of the ranging system.

FIG. 8 is a diagram for explaining a relationship between TDC arrangement and corrected coordinates.

FIG. 9 is a block diagram illustrating a detailed configuration example of a second embodiment of the ranging system.

FIG. 10 is a flowchart for explaining second ranging processing by the second embodiment of the ranging system.

FIG. 11 is a block diagram illustrating a detailed configuration example of a third embodiment of the ranging system.

FIG. 12 is a diagram for explaining correction processing of spatial coordinates in the third embodiment.

FIG. 13 is a flowchart for explaining third ranging processing by the third embodiment of the ranging system.

FIG. 14 is a block diagram illustrating a detailed configuration example of a fourth embodiment of the ranging system.

FIG. 15 is a diagram for explaining arrangement of an illumination device and a ranging device according to the fourth embodiment.

FIG. 16 is a diagram for explaining correction processing of spatial coordinates in the fourth embodiment.

FIG. 17 is a flowchart for explaining fourth ranging processing by the fourth embodiment of the ranging system.

### MODE FOR CARRYING OUT THE INVENTION

Hereinafter, modes for carrying out the present technology (hereinafter, referred to as embodiments) will be described with reference to the accompanying drawings. Note that, in the present specification and the drawings, components having substantially the same functional configuration will be denoted by the same reference signs, and redundant description will be omitted. Description will be made in the following order.
1. Configuration Example of Ranging System of Present Disclosure
2. Problem Handled by Ranging System of Present Disclosure
3. First Embodiment of Ranging System
4. Description of Correction Processing
5. Flowchart of First Ranging Processing
6. Relationship between TDC Arrangement and Corrected Coordinates
7. Second Embodiment of Ranging System
8. Flowchart of Second Ranging Processing
9. Third Embodiment of Ranging System
10. Flowchart of Third Ranging Processing
11. Relationship between Baseline Direction and Corrected Coordinates
12. Fourth Embodiment of Ranging System
13. Flowchart of Fourth Ranging Processing
14. Conclusion

### 1. Configuration Example of Ranging System of Present Disclosure

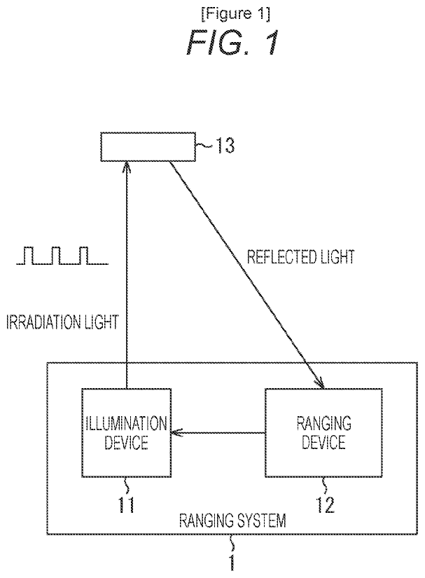

FIG. 1 is a block diagram illustrating a configuration example of a ranging system of the present disclosure.

A ranging system 1 in FIG. 1 is, for example, a system that measures a distance to an object 13 using a time-of-flight (ToF) method to output. Here, the ranging system 1 performs ranging by a direct ToF method among the ToF methods. The direct ToF method is a method of calculating the distance to the object 13 by directly measuring a time of flight of pulse light from when the pulse light as irradiation light is emitted to when reflected light, which is the pulse light reflected by the object 13, is received.

The ranging system 1 can be used together with an external sensor (not illustrated) that images a subject including the object 13 and the like. For example, in a case where the ranging system 1 is used together with an RGB sensor as the external sensor, the ranging system 1 sets the same range as an imaging range of the RGB sensor as a distance measurement range and generates distance information of the subject captured by the RGB sensor.

The ranging system 1 is provided with an illumination device 11 and a ranging device 12, and measures the distance to a predetermined object 13 as the subject. More specifically, for example, when the ranging system 1 is instructed by a higher-level host device and the like to start the measurement, this repeats emission of the pulse light as the irradiation light and reception of the reflected light thereof a predetermined number of times (for example, several to several hundred times) in one frame period in which one (one-frame) depth image is generated. The ranging system 1 generates a histogram of the time of flight of the pulse light on the basis of the emission of the pulse light and the reception of the reflected light thereof repeatedly executed a predetermined number of times, and calculates the distance to the object 13 from the time of flight corresponding to a peak of the histogram.

The illumination device 11 emits the pulse light on the basis of a light emission condition and a light emission trigger supplied from the ranging device 12. The pulse light may be, for example, infrared light (IR light) having a wavelength within a range of approximately 850 nm to 940 nm but not limited thereto. The light emission trigger is, for example, a pulse waveform having two values of “High (1)” and “Low (0)”, and “High” represents a timing of emitting the pulse light. The light emission condition includes, for example, whether the pulse light is emitted by spot emission or surface emission. The spot emission is a method of emitting light including a plurality of circular or elliptical spots regularly arrayed according to a predetermined rule. The surface emission is a method of emitting light with uniform luminance over an entire substantially rectangular predetermined area.

When the ranging device 12 is instructed to start the measurement, this determines the light emission condition, and outputs the determined light emission condition and light emission trigger to the illumination device 11 to emit the pulse light as the irradiation light. Furthermore, the ranging device 12 calculates the distance to the object 13 by receiving the reflected light of the pulse light reflected by the object 13, generates the depth image on the basis of a result thereof, and outputs the same to the higher-level host device and the like as the distance information.

### 2. Problem Handled by Ranging System of Present Disclosure

The ranging device 12 includes a pixel array in which pixels each including a single photon avalanche diode (SPAD) as a photoelectric conversion element are two-dimensionally arranged in a matrix in a light reception unit that receives the reflected light.

In the ranging device 12, it is difficult to provide operation circuits such as a histogram generation unit that generates the histogram of the time of flight of the pulse light, a peak detection unit that detects the peak of the histogram and the like for all the pixels, due to a restriction in circuit area.

Furthermore, it is known that an SN ratio is low and it is difficult to detect a peak position in ranging of a low-reflectivity or distant subject, ranging in an environment where external light has a strong influence of disturbance such as an outdoor environment and the like.

In view of the above, a plurality of adjacent pixels (also referred to as a multipixel) in the pixel array is regarded as one sample point and the histogram is generated in multipixel unit. Therefore, the number of histogram generation units, peak detection units and the like may be smaller than the total number of pixels of the pixel array, and since signals are integrated in the multipixel forming one sample point, the SN ratio is also improved.

Here, when the ranging device 12 outputs the depth image as the distance information, for example, a predetermined position determined in advance such as a center position and an upper left position of the multipixel is set as a representative position of one sample point, for example, and is made an acquisition coordinate position of the distance information (pixel position in an x direction and a y direction of the pixel array).

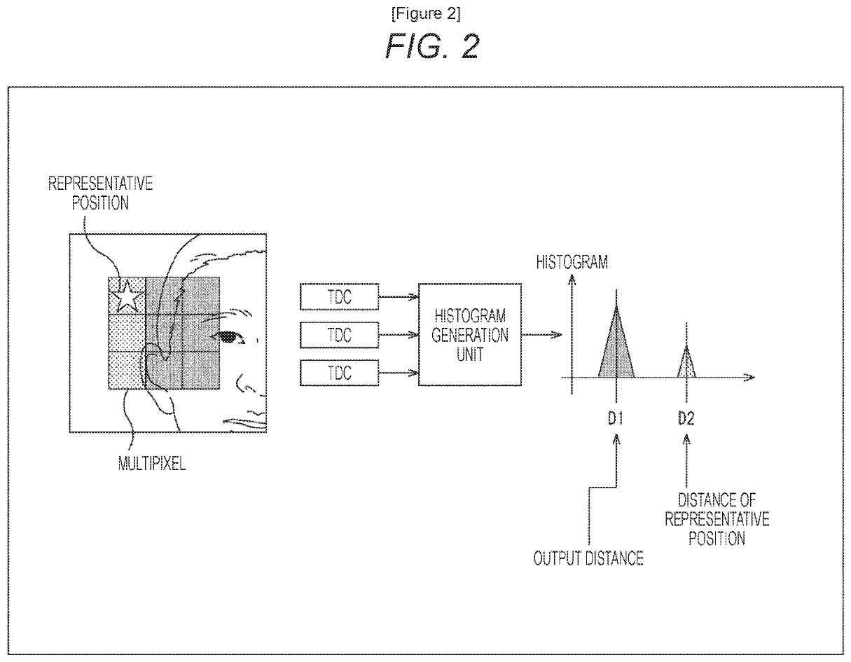

However, as illustrated in FIG. 2, there is a case where the representative position determined in advance is not correct as the acquisition coordinate position of the output distance information.

An example in FIG. 2 illustrates an example in which nine (three by three) pixels form one sample point (multipixel), and an upper left pixel position indicated by a star mark determined in advance is output as the acquisition coordinate position of the distance information. The histogram of the multipixel has two peaks at a distance D1 corresponding to a human face area and a distance D2 corresponding to a background, and the distance D1 corresponding to the face area having a higher peak value is output as the distance information of the multipixel. In contrast, since the acquisition coordinate position of the distance information of the multipixel is the upper left pixel position indicated by the star mark out of the three by three pixels, this corresponds to a position in a background area, so that an error occurs in the spatial coordinates of the distance information.

Such error in the spatial coordinates of the distance information often causes a problem in a subsequent application that uses the distance information, such as an application that densifies the distance information, for example. Therefore, the ranging device 12 is configured to be able to correct the acquisition coordinate position of the distance information and output the distance information with more accurate spatial coordinates.

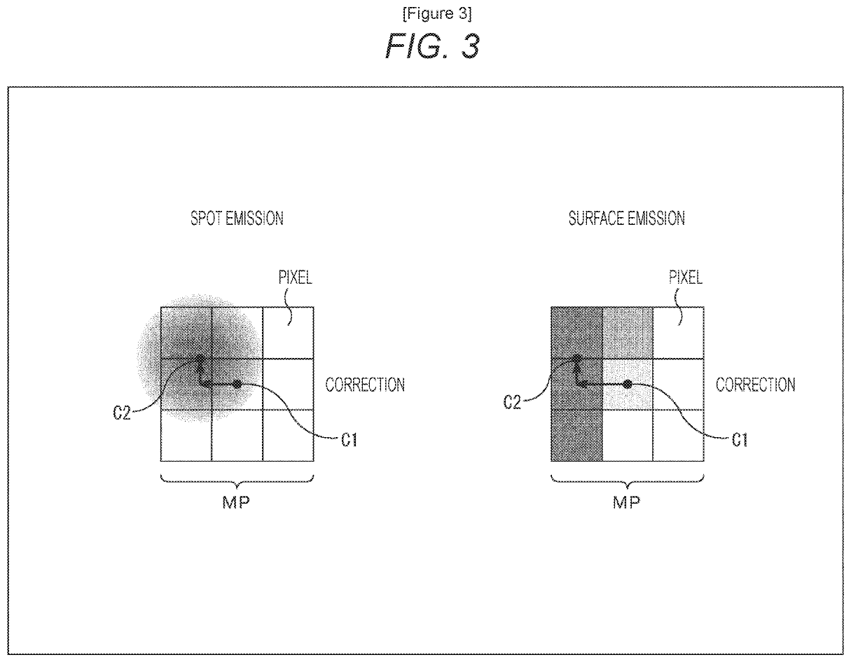

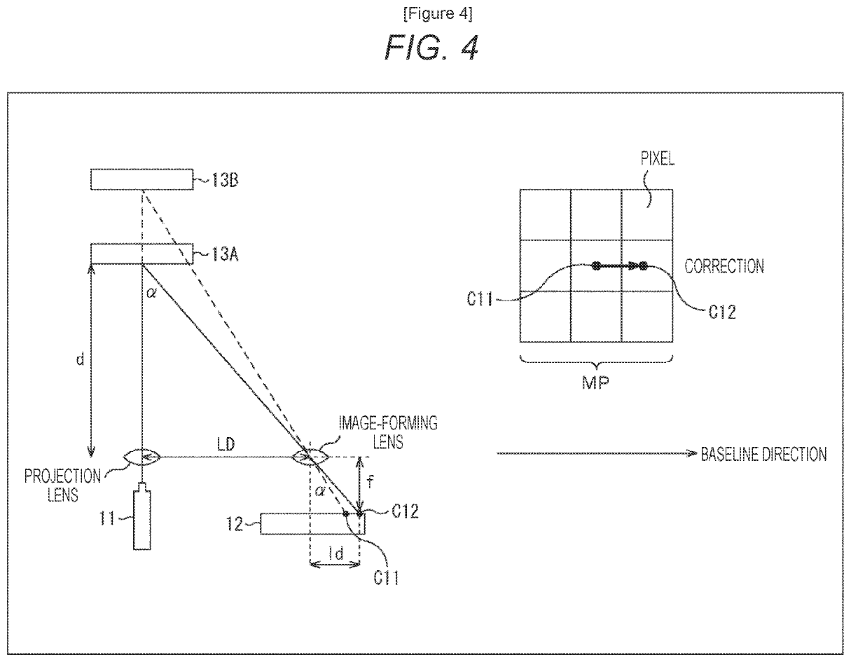

With reference to FIGS. 3 and 4, correction processing of the acquisition coordinate position of the distance information performed by the ranging device 12 is described.

FIG. 3 is a diagram for explaining first correction processing performed by the ranging device 12.

The ranging device 12 corrects the acquisition coordinate position on the basis of a luminance value detected in a multipixel MP set as the sample point. More specifically, the ranging device 12 corrects a representative position C1 of the multipixel MP set as an initial position to a corrected position C2 having a large luminance value detected in the multipixel MP. Images of acquisition coordinate position correction in a case where the irradiation light is emitted by the spot emission, and that in a case where the irradiation light is emitted by the surface emission are illustrated on left and right sides in FIG. 3, respectively. In FIG. 3, luminance of the irradiation light is larger (brighter) as gray density is higher.

FIG. 4 is a diagram for explaining second correction processing performed by the ranging device 12.

The ranging device 12 corrects the acquisition coordinate position on the basis of the distance information (depth value) detected in the multipixel MP set as the sample point. More specifically, a positional relationship between the illumination device 11 and the ranging device 12 is fixed in the ranging system 1, and a distance LD between the illumination device 11 and the ranging device 12, a focal distance f of the ranging device 12 and the like are known. In the ranging device 12, when the distance d to the object 13 is detected as the distance information from the peak of the histogram, a distance ld from the pixel array center can be calculated by the principle of triangulation as illustrated in FIG. 4. Therefore, the ranging device 12 corrects the acquisition coordinate position from the representative position C11 set as the initial position to the corrected position C12 corresponding to the distance ld from the pixel array center.

The position that can be calculated by the principle of triangulation on the basis of the acquired distance is a position in a direction parallel to an epipolar line in the epipolar geometry, and the epipolar line is determined by a baseline connecting the illumination device 11 and the ranging device 12. In the example in FIG. 4, supposing that a baseline direction connecting the illumination device 11 and the ranging device 12 is parallel to the x direction of the pixel array, the position that can be calculated by the principle of triangulation on the basis of the acquired distance is the position in the x direction.

### 3. First Embodiment of Ranging System

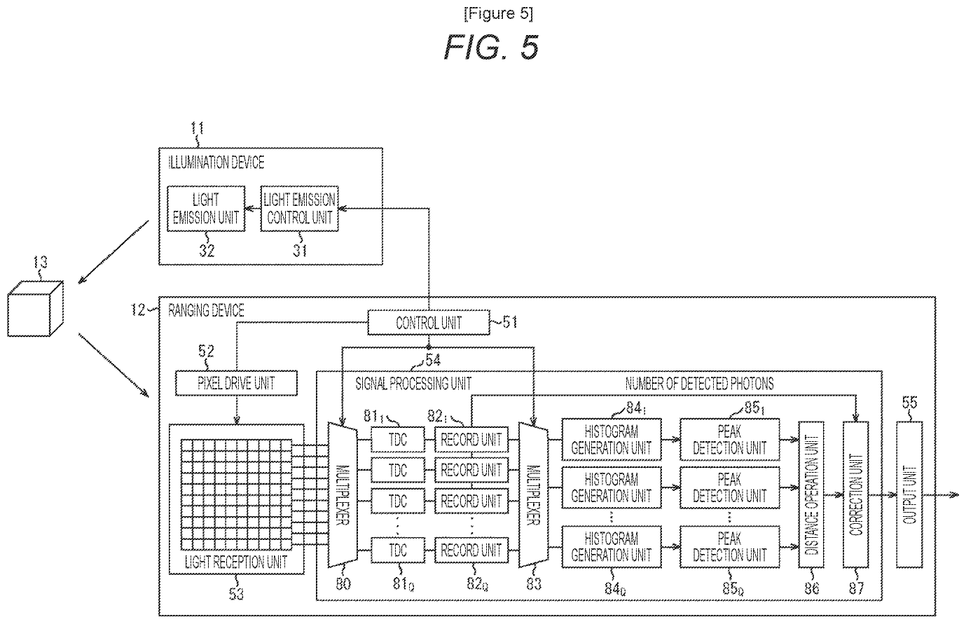

FIG. 5 is a block diagram illustrating a detailed configuration example of a first embodiment of the ranging system 1.

The illumination device 11 is at least provided with a light emission control unit 31 and a light emission unit 32.

The light emission control unit 31 includes, for example, a microprocessor, an LSI, a laser driver and the like, and controls the emission of the pulse light between the spot emission and the surface emission on the basis of the light emission condition supplied from a control unit 51 of the ranging device 12. The light emission control unit 31 can also control a size of the spot light, a light emission position, a light emission area and the like on the basis of the light emission condition. Furthermore, the light emission control unit 31 turns on and off the light emission in accordance with the light emission trigger supplied from the control unit 51 of the ranging device 12.

The light emission unit 32 includes, for example, as a light source, a vertical cavity surface emitting laser (VCSEL) array in which a plurality of VCSELs is planarly arrayed. Each VCSEL of the light emission unit 32 turns on and off the light emission in accordance with the control of the light emission control unit 31.

The ranging device 12 is provided with the control unit 51, a pixel drive unit 52, a light reception unit 53, a signal processing unit 54, and an output unit 55. The signal processing unit 54 includes a multiplexer 80, TDCs 81₁ to 81_{Q}, record units 82₁ to 82_{Q}, a multiplexer 83, histogram generation units 84₁ to 84_{Q}, peak detection units 85₁ to 85_{Q}, a distance operation unit 86, and a correction unit 87. The signal processing unit 54 may include, for example, a field programmable gate array (FPGA), a digital signal processor (DSP), a logic circuit and the like.

The signal processing unit 54 is provided with Q (Q>1) TDCs 81, Q record units 82, Q histogram generation units 84, and Q peak detection units 85, and the signal processing unit 54 can generate Q histograms. A value of Q corresponds to the maximum number of sample points that can be set in the light reception unit 53, is smaller than the total number of pixels of the pixel array of the light reception unit 53, and is the same as or larger than the number of columns or the number of rows of the pixel array. One pixel or a plurality of pixels form the sample point, and in this embodiment, a plurality of pixels, that is, the multipixel forms the same in order to improve the SN ratio as described above. For example, the center position of the multipixel is set as the initial position of the representative position of the sample point.

The control unit 51 including, for example, a field programmable gate array (FPGA), a digital signal processor (DSP), a microprocessor and the like determines the light emission condition when instructed to start the measurement, and supplies the determined light emission condition and light emission trigger to the light emission control unit 31 of the illumination device 11. Although a signal line is not illustrated in FIG. 5, the light emission trigger is also supplied to the signal processing unit 54 as a notification of timing to start counting the time of flight.

Furthermore, the control unit 51 determines a plurality of sample points (multipixels) in the light reception unit 53 corresponding to the determined light emission condition, for example, the light emission position of the spot light and the like. The control unit 51 supplies active pixel control information in which each pixel of the light reception unit 53 determined as the sample point is made an active pixel to the pixel drive unit 52. The active pixel is a pixel that detects incidence of a photon. The pixel that does not detect the incidence of the photon is referred to as an inactive pixel.

Moreover, the control unit 51 supplies information indicating a forming unit of the multipixel of the light reception unit 53 to the multiplexers 80 and 83 of the signal processing unit 54 as multipixel control information.

The pixel drive unit 52 controls the active pixel and the inactive pixel on the basis of the active pixel control information supplied from the control unit 51. In other words, the pixel drive unit 52 controls on and off of a light reception operation of each pixel of the light reception unit 53.

The light reception unit 53 includes the pixel array in which the pixels are two-dimensionally arranged in a matrix. Each pixel of the light reception unit 53 is provided with a single photon avalanche diode (SPAD) as a photoelectric conversion element. The SPAD instantaneously detects one photon by multiplying a carrier generated by photoelectric conversion in a high electric field PN junction region (multiplication region). When the incidence of the photon is detected by each pixel set as the active pixel in the light reception unit 53, a detection signal indicating that the photon is detected is output to the multiplexer 80 of the signal processing unit 54 as a pixel signal.

The multiplexer 80 distributes the pixel signal supplied from the active pixel of the light reception unit 53 to any one of the TDCs 81₁ to 81_{Q} on the basis of the multipixel control information from the control unit 51. For example, the multiplexer 80 makes the column of the pixel array correspond to the TDC 81 on one-to-one basis, and controls the pixel signal output from the light reception unit 53 in such a manner that the pixel signal of each active pixel in the same column is supplied to the same TDC 81ᵢ (i=any one of 1 to Q).

The pixel signal of the corresponding column is supplied from the multiplexer 80 to the TDC 81ᵢ (i=any one of 1 to Q). Furthermore, the light emission trigger output from the control unit 51 to the illumination device 11 is also supplied to the TDC 81ᵢ. The TDC 81ᵢ generates a digital count value corresponding to the time of flight of the pulse light on the basis of the light emission timing indicated by the light emission trigger and the pixel signal supplied from each active pixel. The generated count value is supplied to the corresponding record unit 82ᵢ.

The record unit 82ᵢ supplies the digital count value corresponding to the time of flight supplied from the corresponding TDC 81ᵢ to the multiplexer 83. Furthermore, the record unit 82ᵢ records the number of detected photons on the basis of the count value supplied from the TDC 81ᵢ in one frame period in which the emission of the irradiation light and the reception of the reflected light thereof are repeated a predetermined number of times. After the light emission and light reception corresponding to one frame period are finished, the record unit 82ᵢ supplies the final number of the detected photons to the correction unit 87. In this embodiment, the TDC 81ᵢ and the record unit 82ᵢ are provided so as to correspond to the column of the pixel array on one-to-one basis, so that the number of detected photons supplied to the correction unit 87 is the number of detected photons in units of columns.

The multiplexer 83 distributes the digital count value corresponding to the time of flight supplied from the record unit 82ᵢ to any one of the histogram generation units 84₁ to 84_{Q} on the basis of the multipixel control information from the control unit 51. More specifically, the multiplexer 83 controls the count value from the record unit 82ᵢ in such a manner that the count values of the columns belonging to the same multipixel are supplied to the same histogram generation unit 84ᵢ.

The multiplexer 80 described above outputs the pixel signals of a plurality of pixels in a column direction belonging to the same multipixel to the same TDC 81ᵢ, and the multiplexer 83 outputs the count values of a plurality of rows belonging to the same multipixel to the same histogram generation unit 84ᵢ, so that the count values in multipixel unit are collected in one histogram generation unit 84ᵢ.

The histogram generation unit 84ᵢ creates the histogram of the count values regarding a predetermined multipixel on the basis of the count values supplied from the multiplexer 83. Data of the generated histogram is supplied to the corresponding peak detection unit 85ᵢ.

The peak detection unit 85ᵢ detects the peak of the histogram on the basis of the data of the histogram supplied from the histogram generation unit 84ᵢ. The peak detection unit 85ᵢ supplies the count value corresponding to the detected peak of the histogram to the distance operation unit 86.

The distance operation unit 86 calculates the time of flight in each sample point on the basis of the count value corresponding to the peak of the histogram supplied from each of the peak detection units 85₁ to 83_{Q} in units of sample points (multipixels). Moreover, the distance operation unit 86 performs an arithmetic operation of the distance to the subject from the calculated time of flight, and generates a depth image in which the distance as an operation result is associated with the spatial coordinates (x coordinate and y coordinate) of the sample point. The generated depth image is supplied to the correction unit 87. The spatial coordinates of the sample point at that time indicate the center position of the multipixel set as the initial position.

The correction unit 87 is supplied with the number of detected photons in division units obtained by dividing the multipixel forming the sample point into units of columns from each of the record units 82₁ to 82_{Q}. Furthermore, the depth image as the distance information of the sample point is supplied from the distance operation unit 86 to the correction unit 87.

The correction unit 87 corrects the spatial coordinates of the sample point on the basis of the luminance value detected in the multipixel forming the sample point. More specifically, the correction unit 87 corrects the representative position of the sample point on the basis of the number of detected photons in units of columns of the multipixel supplied from each of the record units 82₁ to 82_{Q}. The correction processing will be described later in detail.

The output unit 55 outputs, to an external device, for example, the higher-level host device, the depth image supplied from (the correction unit 87 of) the signal processing unit 54. The output unit 55 can include, for example, a communication interface and the like conforming to mobile industry processor interface (MIPI).

### 4. Description of Correction Processing

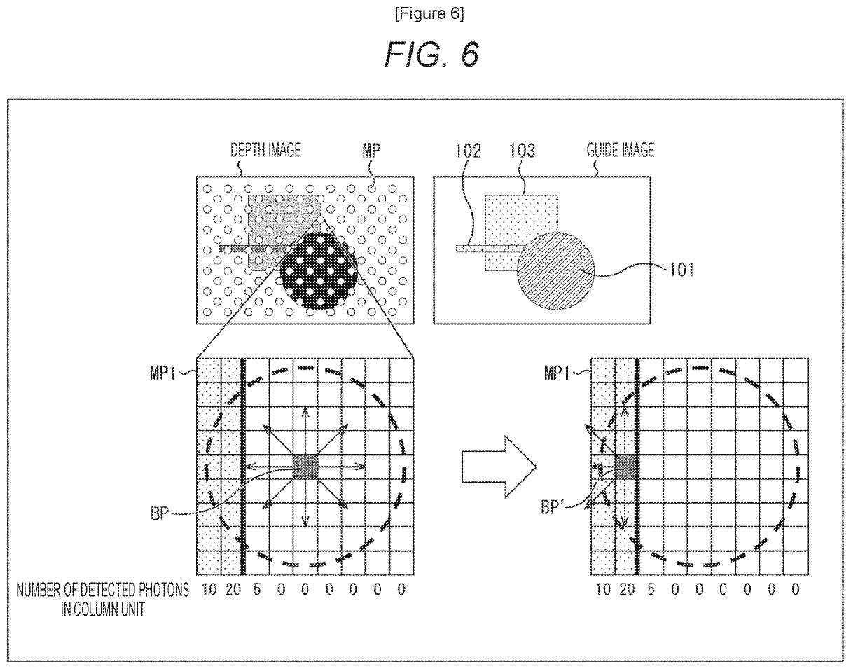

With reference to FIG. 6, correction processing of the spatial coordinates by the correction unit 87 will be described.

FIG. 6 illustrates the depth image generated by the distance operation unit 86 and a guide image obtained by imaging the same measurement range as that of the depth image with the RGB sensor as the external sensor.

Three objects 101, 102, and 103 are imaged in the guide image. In the depth image, distance information corresponding to the objects 101, 102, and 103 and other backgrounds is represented by gray values. In the depth image, the gray values representing the distance information are represented by, for example, 8-bit values, and the smaller the bit value (closer to black), the shorter the distance.

Note that, white circles arranged at predetermined intervals in the depth image represent sample points set in the pixel array, that is, multipixels MP. The white circle of each multipixel MP superimposed on the depth image represents the position of the sample point as a reference, and is not related to the gray value representing the distance information.

It is described focusing on a predetermined multipixel MP1 in the depth image. In an example in FIG. 6, the multipixel MP1 includes 81 (nine by nine) pixels. In the multipixel MP1, a thick line between second and third columns from the left side corresponds to a boundary of the object 103.

The distance information calculated for the multipixel MP1 is supplied from the distance operation unit 86 to the correction unit 87. The representative position of the distance information at that time is a center position BP of the multipixel MP1 set as the initial position. Furthermore, the number of detected photons calculated in units of columns for the multipixel MP1 is supplied from a predetermined record unit 82ᵢ to the correction unit 87.

In the example in FIG. 6, when each column of the multipixel MP1 is set to a first column, a second column, and the like from the left side, the number is “10” for the first column, “20” for the second column, “5” for the third column, and “0” for the fourth to ninth columns.

The correction unit 87 corrects the representative position of the multipixel MP1 from the position BP to a position BP′ on the basis of the number of detected photons in units of columns of the multipixel MP1. That is, the correction unit 87 corrects the representative position of the multipixel MP1 to the position BP′ of the column having the largest number of detected photons among the number of detected photons in units of columns supplied from the predetermined record unit 82ᵢ (that is, the second column). Since the spatial coordinates of the multipixel MP1 are corrected on the basis of the number of detected photons in units of columns, only the x coordinate corresponding to the column of the pixel array is corrected.

The correction unit 87 may correct the representative position of the multipixel MP1 by another method using the number of detected photons.

For example, the correction unit 87 may make a weighted mean position weighted by the number of detected photons in units of columns of the multipixel MP1 the representative position of the multipixel MP1.

Furthermore, for example, the correction unit 87 may approximate the number of detected photons in units of columns of the multipixel MP1 by a predetermined function, and make a position at which the number of detected photons is the largest in an approximation function the representative position of the multipixel MP1. For example, a position at which the number of detected photons is the largest by parabola fitting is made the representative position of the multipixel MP1.

Furthermore, for example, the correction unit 87 may make the position at which the number of detected photons within a certain range is the largest the representative position of the multipixel MP1 by using a mean shift procedure on the number of detected photons in units of columns.

By correcting the representative position by using not only the largest value of the number of detected photons but also other numbers of detected photons, it is possible to improve robustness to noise and obtain an estimation result of subpixel accuracy.

The correction unit 87 may make a position obtained by adding a predetermined offset amount to the corrected position based on the number of detected photons as a final position after correction. A moving direction of the offset amount is an extending direction of the corrected position based on the number of detected photons from the position before the correction. As in the example in FIG. 6, in a case where the corrected position based on the number of detected photons is in the vicinity of an object boundary, the position after the correction can be set to a position away from the object boundary by adding a predetermined offset amount. Therefore, the spatial coordinates suitable for up-sampling can be obtained.

### 5. Flowchart of First Ranging Processing

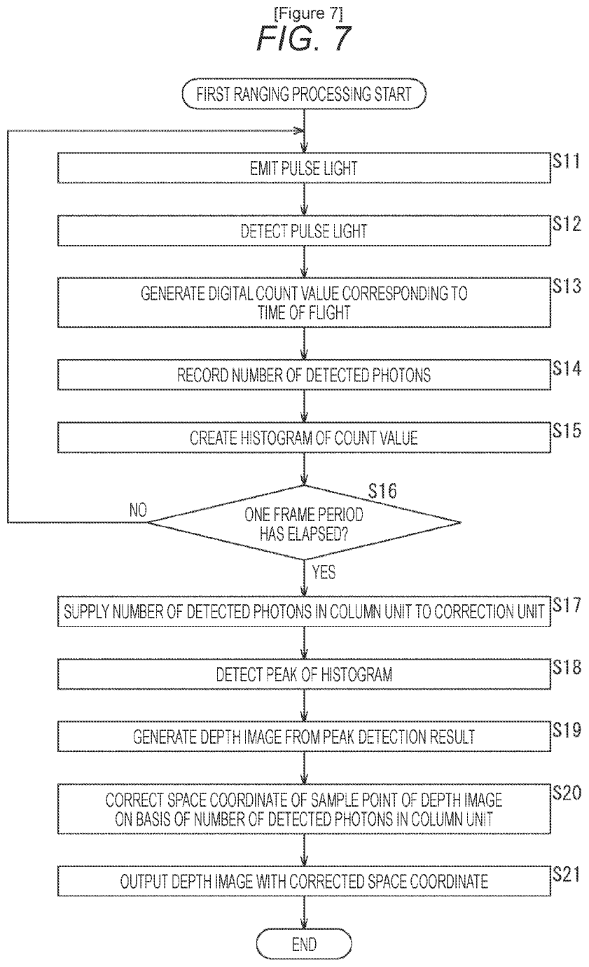

Ranging processing (first ranging processing) by the first embodiment of the ranging system 1 will be described with reference to a flowchart in FIG. 7. This processing is started when there is an instruction by the higher-level host device and the like to start the measurement, for example.

First, at step S11, the illumination device 11 emits the pulse light. More specifically, the control unit 51 of the ranging device 12 determines the light emission condition, and supplies the determined light emission condition and light emission trigger to the light emission control unit 31 of the illumination device 11. The illumination device 11 emits the pulse light on the basis of the light emission condition and the light emission trigger from the control unit 51.

At step 512, the light reception unit 53 of the ranging device 12 detects the pulse light (reflected light) emitted from the illumination device 11 as the irradiation light and reflected by the object 13 to be returned. More specifically, the control unit 51 determines a plurality of sample points (multipixels) for the pixel array of the light reception unit 53, and supplies the active pixel control information in which each pixel determined as the sample point is made the active pixel to the pixel drive unit 52. When the pixel drive unit 52 drives the active pixel of the light reception unit 53, and the incidence of the photon is detected by the active pixel, a detection signal indicating the detection of the photon is output as the pixel signal to a predetermined TDC 81ᵢ via the multiplexer 80.

At step S13, the TDC 81ᵢ generates the digital count value corresponding to the time of flight from when the light emission unit 32 emits the pulse light to when the active pixel receives the reflected light on the basis of the pixel signal sequentially supplied from each pixel of the corresponding column. The generated count value is supplied to the corresponding record unit 82ᵢ.

At step S14, the record unit 82ᵢ supplies the digital count value supplied from the corresponding TDC 81ᵢ to the multiplexer 83, and records the number of detected photons on the basis of the supplied count value. The count value supplied to the multiplexer 83 is supplied to the histogram generation unit 84ᵢ corresponding to the record unit 82ᵢ.

At step S15, the histogram generation unit 84ᵢ creates the histogram of the count values for a predetermined multipixel on the basis of the count values supplied from the corresponding record unit 82ᵢ via the multiplexer 83.

At step S16, the control unit 51 determines whether or not one frame period elapses. In a case where it is determined that one frame period does not elapse yet, the procedure returns to step S11 and the above-described processing at steps S11 to S16 is repeated. Therefore, the emission of the irradiation light and the reception of the reflected light thereof are repeated a predetermined number of times, and the data of the histogram is updated.

Then, in a case where it is determined at step S16 that one frame period elapses, the procedure shifts to step S17, and each of the record units 82₁ to 82_{Q} supplies the recorded number of detected photons in units of columns to the correction unit 87. Furthermore, at step S17, the histogram generation unit 84ᵢ supplies the data of the generated histogram to the corresponding peak detection unit 85ᵢ.

At step S18, the peak detection unit 85ᵢ detects the peak of the histogram on the basis of the data of the histogram supplied from the corresponding histogram generation unit 84ᵢ. The peak detection unit 85ᵢ supplies the count value corresponding to the detected peak of the histogram to the distance operation unit 86.

At step S19, the distance operation unit 86 generates the depth image from a peak detection result of each of the peak detection units 85₁ to 83_{Q}. Specifically, the distance operation unit 86 calculates the time of flight from the count value corresponding to the peak, and further performs an arithmetic operation of the distance to the subject from the calculated time of flight. Then, the distance operation unit 86 generates the depth image in which the spatial coordinates (x coordinate and y coordinate) of the sample point and the calculated distance are associated with each other, and supplies the same to the correction unit 87. The spatial coordinates of the sample point at that time indicate the center position of the multipixel set as the initial position.

At step S20, the correction unit 87 corrects the spatial coordinates of the sample point (multipixel) of the depth image on the basis of the number of detected photons in units of columns supplied from each of the record units 82₁ to 82_{Q}. More specifically, the correction unit 87 corrects the coordinates to the position of the column having the largest number of detected photons among the number of detected photons in units of columns forming the multipixel.

At step S21, the correction unit 87 outputs the depth image to the output unit 55 with the spatial coordinates after the correction. The output unit 55 outputs the depth image supplied from the correction unit 87 to an external device.

According to the first ranging processing described above, it is possible to correct the spatial coordinates of the multipixel, which is the sample point, on the basis of the luminance value (the number of detected photons) detected in the pixel array. Therefore, the acquisition coordinate position of the subject the distance information of which is acquired can be output with higher accuracy. Specification of the subject coordinates is important in a subsequent application that densifies an acquired signal (distance information) and the like. Since the acquisition coordinate position of the distance information can be output with higher accuracy, efficient densification and resolution enhancement of sparse acquired signals can be implemented in the subsequent application.

<Variation of First Ranging Processing>

At step S20 described above, filtering of the number of detected photons in units of columns supplied from each of the record units 82₁ to 82_{Q} may be performed before performing the correction processing of the spatial coordinates based on the number of detected photons in units of columns. As the filtering processing, for example, a mean filter, a Gaussian filter, a median filter and the like can be employed. Therefore, noise resistance can be improved.

In the first ranging processing described above, the correction unit 87 corrects only the spatial coordinates of the sample point (multipixel) and does not correct the distance information, but may also correct the distance information on the basis of the number of detected photons in units of columns.

Specifically, when the position of the spot light is known, the distance can be obtained by the principle of triangulation in FIG. 4. The correction unit 87 may generate the depth image in which the distance is replaced with the distance calculated on the basis of the position of the spot light as the distance after correction to output. Alternatively, a distance obtained by α-blending the distance calculated by the distance operation unit 86 and the distance calculated on the basis of the position of the spot light with a predetermined coefficient α₁ (0<α₁<1) may be output. Since distance resolution of the direct ToF method is determined by a bin width of the histogram, the operation by triangulation has a higher distance resolution than that of the direct ToF method at a short distance. By employing the distance calculated by the principle of triangulation, the distance resolution at a short distance can be improved.

### 6. Relationship Between TDC Arrangement and Corrected Coordinates

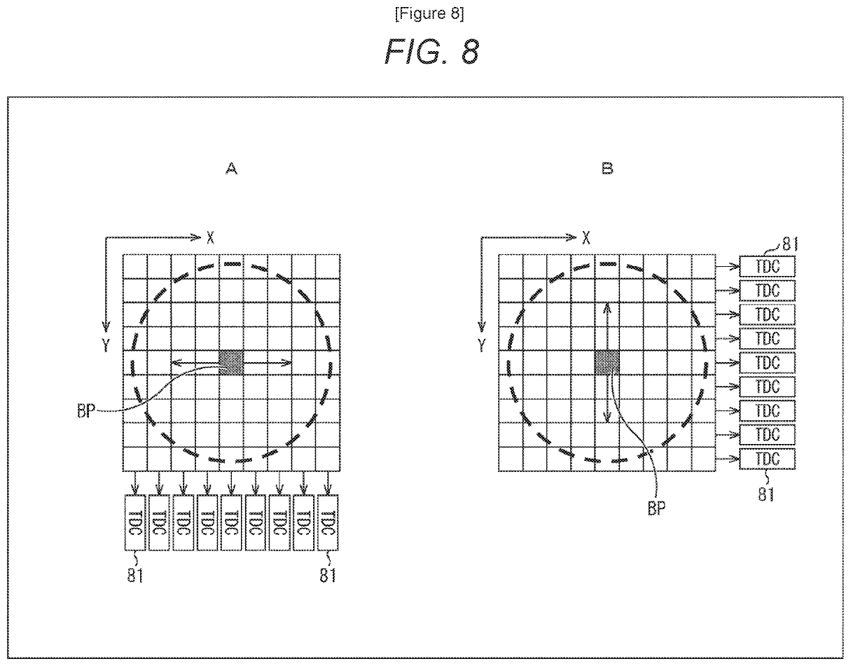

In the description of the first embodiment described above, as illustrated in A of FIG. 8, the TDC 81 is arranged corresponding to the column direction of the pixel array, and the TDC 81 is shared by the respective pixels arrayed in the same column. In this case, since the TDC 81 counts the number of detected photons in units of columns as division units of the sample point (multipixel), the coordinate corrected by the correction processing is the x coordinate corresponding to the column of the pixel array.

In contrast, as illustrated in B of FIG. 8, it is also possible to adopt a configuration in which the TDC 81 is arranged for the row direction of the pixel array and the TDC 81 is shared by the respective pixels arrayed in the same row. In this case, since the TDC 81 counts the number of detected photons in units of rows as division units of the sample point (multipixel), the coordinate corrected by the correction processing is the y coordinate corresponding to the row of the pixel array.

Moreover, in any of the TDC arrangements in A and B of FIG. 8, for example, both the x coordinate and the y coordinate as explained in FIG. 3 can be corrected by controlling the pixel signal of each pixel of a plurality of rows or a plurality of columns such as two by four pixels to be output to the same TDC 81, for example, under the control of the multiplexer 80.

### 7. Second Embodiment of Ranging System

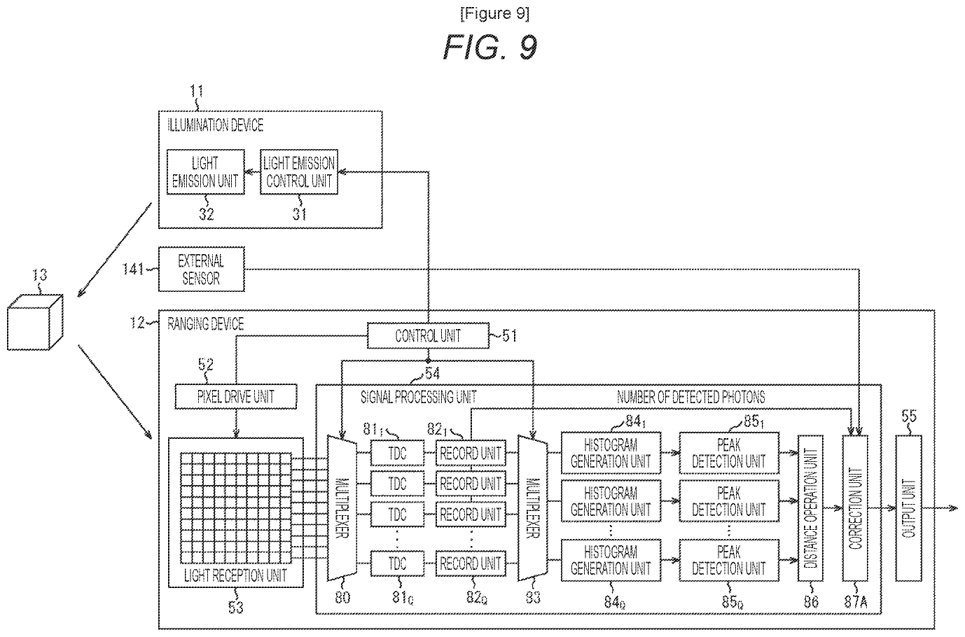

FIG. 9 is a block diagram illustrating a detailed configuration example of a second embodiment of the ranging system 1.

In FIG. 9, parts corresponding to those of the first embodiment illustrated in FIG. 5 are denoted by the same reference numerals, description of the parts is omitted as appropriate, and it is described focusing on different parts.

The second embodiment in FIG. 9 is different from the first embodiment described above in that an external sensor 141 is newly added. Furthermore, in the ranging device 12, the correction unit 87 of the first embodiment is replaced with a correction unit 87A. Other configurations of the second embodiment are similar to those of the first embodiment illustrated in FIG. 5.

The external sensor 141 can be, for example, an RGB sensor or a monochrome sensor that receives light in a visible light wavelength band. Alternatively, the external sensor 141 may be, for example, an NIR sensor that receives light in a near infrared (NIR) wavelength band or a sensor that receives light in other wavelength bands. A light receiving range of the external sensor 141 is adjusted to be the same as a ranging range of the ranging device 12.

In the following description, it is described supposing that the external sensor 141 is the monochrome sensor.

The monochrome sensor as the external sensor 141 generates a monochrome image in the same imaging range as the ranging range of the ranging device 12 at a predetermined frame rate, and outputs the same to the ranging device 12. The monochrome image from the external sensor 141 is supplied to the correction unit 87A via an input unit (not illustrated) of the ranging device 12. The external sensor 141 can generate at least one monochrome image in one frame period in which the ranging device 12 generates one depth image.

The correction unit 87A corrects the spatial coordinates of the multipixel, which is the sample point in the pixel array, on the basis of a luminance value of the monochrome image supplied from the external sensor 141.

That is, in the first embodiment described above, the correction unit 87 corrects the spatial coordinates of the multipixel on the basis of the number of detected photons supplied from each of the record units 82₁ to 82_{Q}, but the correction unit 87A of the second embodiment is different in that the spatial coordinates of the multipixel are corrected using the luminance value detected by the external sensor 141 in place of the number of detected photons. The correction processing can be performed similarly to that with the number of detected photons in the first embodiment, but since the luminance value of the monochrome image is not related to the arrangement of the TDC 81 as explained in FIG. 8, both the x coordinate and the y coordinate can be corrected.

Alternatively, the correction unit 87 A can also correct the spatial coordinates of the multipixel as the sample point using both the luminance value of the monochrome image supplied from the external sensor 141 and the number of detected photons supplied from each of the record units 82₁ to 82_{Q}. Specifically, the correction unit 87A may output the corrected coordinates obtained by α-blending the corrected coordinates based on the luminance value of the monochrome image and the corrected coordinates based on the number of detected photons with a predetermined coefficient α₂ (0<α₂<1) as the representative position of the multipixel after the correction.

The correction unit 87A may use the luminance value of the monochrome image as auxiliary information in consideration of an influence of a difference in reflectance of the subject. Specifically, the correction unit 87A corrects the spatial coordinates of the multipixel using a value (normalized number of detected photons) obtained by normalizing the number of detected photons by dividing the number of detected photons from each record unit 82₁ by the luminance value of the monochrome image. In this case, the spatial coordinates can be corrected by the number of detected photons obtained by correcting the influence of the difference in reflectance of the subject.

Note that, at the time of normalization, instead of using the luminance value of the monochrome image as is, a value obtained by estimating the luminance value of the same wavelength band (IR band) as that of the light source of the illumination device 11 may be used.

Furthermore, the correction unit 87A may appropriately select the luminance value as the basis of the correction processing depending on the presence or absence of the external sensor 141 so as to correct on the basis of the luminance value of the monochrome image in a case where the external sensor 141 is connected, and to correct on the basis of the number of detected photons in a case where the external sensor 141 is not connected.

Although a case where the external sensor 141 is the monochrome sensor has been described, it is possible to similarly correct also in a case where the external sensor 141 is the RGB sensor or the NIR sensor. In a case where the external sensor 141 is the RGB sensor, the luminance value converted from the RGB value output from the RGB sensor is only required to be used.

### 8. Flowchart of Second Ranging Processing

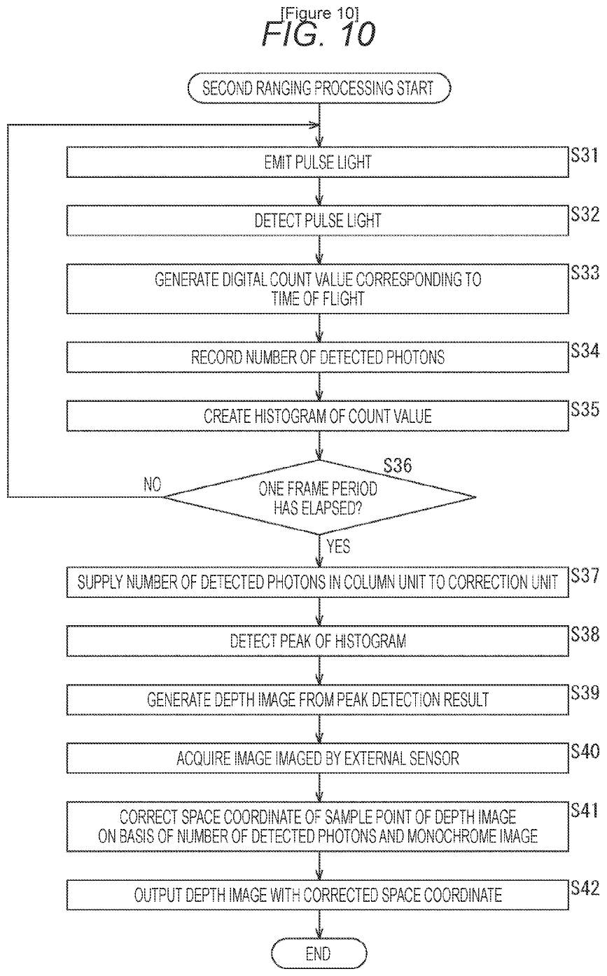

Ranging processing (second ranging processing) by the second embodiment of the ranging system 1 will be described with reference to a flowchart in FIG. 10. This processing is started when there is an instruction by the higher-level host device and the like to start the measurement, for example.

In the second ranging processing in FIG. 10, an example in which the correction unit 87A outputs the corrected coordinates obtained by α-blending the corrected coordinates based on the luminance value of the monochrome image and the corrected coordinates based on the number of detected photons with a predetermined coefficient α₂ as the representative position of the multipixel after the correction is described

The processing at steps S31 to S39 is similar to the processing at steps S11 to S19 in the first ranging processing in FIG. 7, so that the description thereof will be omitted.

At step S40, the correction unit 87A of the ranging device 12 acquires an image captured by the external sensor 141. In this embodiment, the correction unit 87A acquires a monochrome image from the external sensor 141, which is a monochrome sensor.

At step S41, the correction unit 87A corrects the spatial coordinates of the sample point (multipixel) of the depth image on the basis of the number of detected photons supplied from each of the record units 82₁ to 82_{Q} and the monochrome image supplied from the external sensor 141. More specifically, the correction unit 87A makes the corrected coordinates obtained by α-blending the corrected coordinates based on the luminance value of the monochrome image and the corrected coordinates based on the number of detected photons with a predetermined coefficient α₂ the representative position of the multipixel after the correction.

Note that, as described above, the correction processing at step S41 may be performed using only the luminance value of the monochrome image or using the normalized number of detected photons.

At step S42, the correction unit 87A outputs the depth image with the spatial coordinates after the correction. The depth image output from the correction unit 87A is output from the output unit 55 to an external device, and the second ranging processing is finished. Similarly to the variation of the first ranging processing, the distance information may also be corrected on the basis of the luminance value of the monochrome image or the number of detected photons to be output.

According to the second ranging processing described above, it is possible to correct the spatial coordinates of the multipixel, which is the sample point, using only the luminance value of the image obtained by the external sensor 141 or both the luminance value of the image and the number of detected photons. Therefore, the acquisition coordinate position of the subject the distance information of which is acquired can be output with higher accuracy. Specification of the subject coordinates is important in a subsequent application that densifies an acquired signal (distance information) and the like. Since the acquisition coordinate position of the distance information can be output with higher accuracy, efficient densification and resolution enhancement of sparse acquired signals can be implemented in the subsequent application. By also using the information obtained by the external sensor 141, high accuracy by sensor fusion can be implemented.

### 9. Third Embodiment of Ranging System

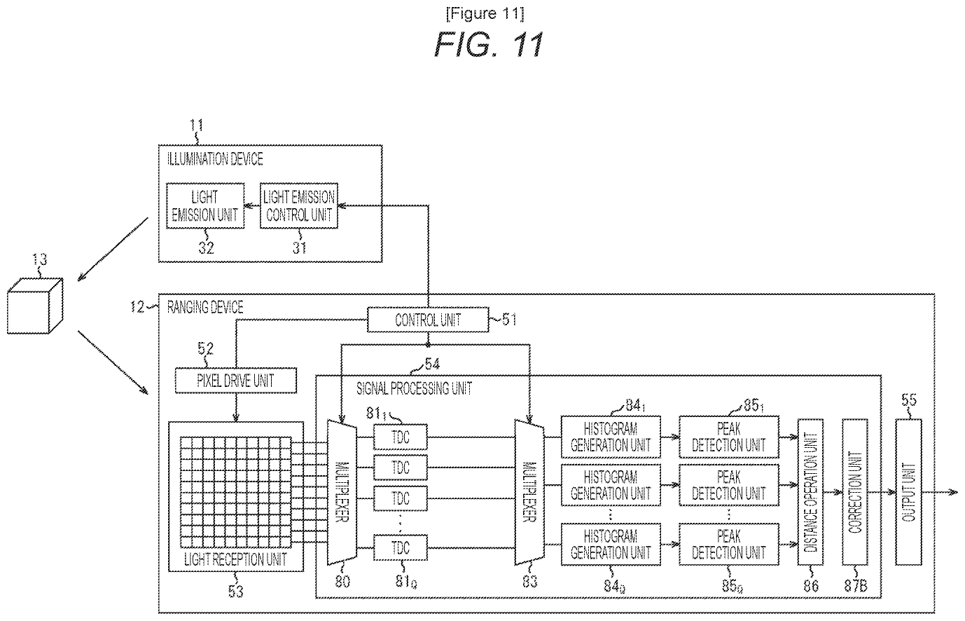

FIG. 11 is a block diagram illustrating a detailed configuration example of a third embodiment of the ranging system 1.

In FIG. 11 also, parts corresponding to those of the first embodiment explained in FIG. 5 are denoted by the same reference numerals, description of the parts is omitted as appropriate, and it is described focusing on different parts.

In the third embodiment in FIG. 11, the correction unit 87 of the first embodiment illustrated in FIG. 5 is replaced with a correction unit 87B. Furthermore, the record units 82₁ to 82_{Q} are omitted, and the outputs of the TDCs 81₁ to 81_{Q} are supplied to the multiplexer 83 as is. Other configurations of the ranging system 1 are similar to those of the first embodiment.

The correction unit 87B according to the second embodiment corrects the acquisition coordinate position by the second correction processing described with reference to FIG. 4, that is, the correction using the distance information (depth value) detected in the multipixel. Since the number of detected photons is not used, the record units 82₁ to 82_{Q} are omitted.

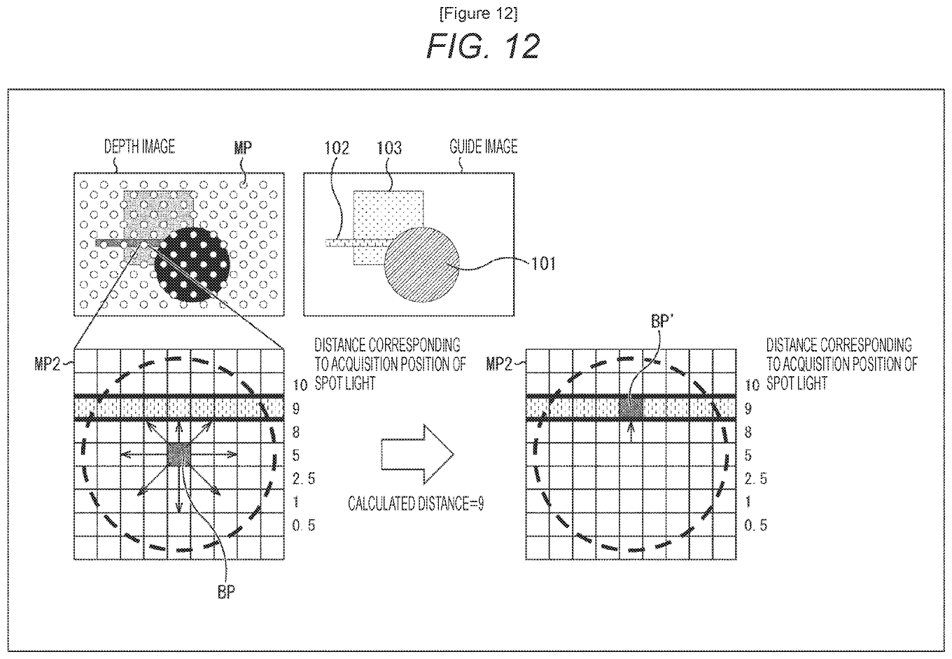

With reference to FIG. 12, correction processing of the spatial coordinates of the multipixel by the correction unit 87B will be described.

The guide image and the depth image illustrated in FIG. 12 are similar to those in FIG. 6, so that the description thereof is omitted.

It is described focusing on a predetermined multipixel MP2 in the depth image. The multipixel MP2 includes 81 (nine by nine) pixels. In the multipixel MP2, supposing that it is referred to as a first row, a second row, a third row, . . . , from the top row, thick lines above and below the third row correspond to a boundary of the object 102.

The distance information calculated for the multipixel MP2 is supplied from the distance operation unit 86 to the correction unit 87B. The representative position of the distance information at that time is a center position BP of the multipixel MP2 set as the initial position. Here, suppose that the distance calculated by the distance operation unit 86 for the multipixel MP2 and supplied is 9 m.

Suppose that a direction parallel to a baseline direction connecting the illumination device 11 and the ranging device 12 is a vertical direction (y direction) of the pixel array.

By the principle of triangulation described with reference to FIG. 4, a position where the spot light returns, in other words, the position in the y direction parallel to the baseline direction is determined according to the distance to the object. For example, as illustrated in FIG. 12, it is determined as the position of the second row of the multipixel MP2 in a case where the distance is 10 m, the position of the third row of the multipixel MP2 in a case where the distance is 9 m, the position of the fourth row of the multipixel MP2 in a case where the distance is 8 m, the position of the fifth row of the multipixel MP2 in a case where the distance is 5 m, . . . and the like.

Since the distance supplied from the distance operation unit 86 for the multipixel MP2 is 9 m, the correction unit 87B corrects that the spot light is received at the position of the third row. That is, the correction unit 87B corrects the representative position of the multipixel MP2 from the position BP to a position BP′ on the basis of the distance information of the multipixel MP2. Since the spatial coordinates of the multipixel are corrected in the direction parallel to the baseline direction, only the y coordinate corresponding to the row of the pixel array is corrected.

### 10. Flowchart of Third Ranging Processing

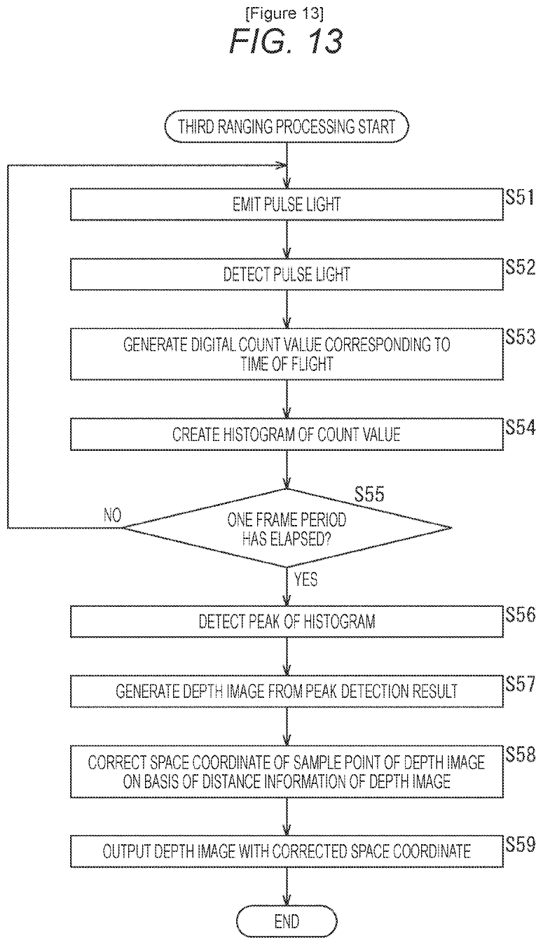

Ranging processing (third ranging processing) by the third embodiment of the ranging system 1 will be described with reference to a flowchart in FIG. 13. This processing is started when there is an instruction by the higher-level host device and the like to start the measurement, for example.

The processing at steps S51 to S57 is similar to the processing at steps S11 to S19 from which steps S14 and S17 are omitted in the first ranging processing in FIG. 7, so that the description thereof will be omitted. That is, the depth image is generated from the peak detection result of the histogram similarly to steps S11 to S19 of the first ranging processing except that the processing in which each record unit 82 records the number of detected photons and supplies the same to the correction unit 87B is omitted.

At step S58, the correction unit 87B of the ranging device 12 corrects the spatial coordinates of the sample point (multipixel) of the depth image on the basis of the distance information of the depth image supplied from the distance operation unit 86. That is, as described with reference to FIG. 12, the spatial coordinates of the sample point are corrected to the position corresponding to the calculated distance.

At step S59, the correction unit 87B outputs the depth image with the spatial coordinates after the correction. The depth image output from the correction unit 87B is output from the output unit 55 to an external device, and the third ranging processing is finished.

According to the third ranging processing described above, it is possible to correct the spatial coordinates of the multipixel, which is the sample point, using the distance information the arithmetic operation of which is performed by the distance operation unit 86. Therefore, the acquisition coordinate position of the subject the distance information of which is acquired can be output with higher accuracy. Specification of the subject coordinates is important in a subsequent application that densifies an acquired signal (distance information) and the like. Since the acquisition coordinate position of the distance information can be output with higher accuracy, efficient densification and resolution enhancement of sparse acquired signals can be implemented in the subsequent application.

### 11. Relationship Between Baseline Direction and Corrected Coordinates

In the description of the third embodiment described above, the illumination device 11 and the ranging device 12 are arranged in such a manner that the y direction of the pixel array is parallel to the baseline direction connecting the illumination device 11 and the ranging device 12, and the correction unit 87B corrects the y coordinate in the spatial coordinates (x coordinate and y coordinate) of the sample point (multipixel) on the basis of the distance information of the depth image supplied from the distance operation unit 86.

In contrast, a configuration in which the illumination device 11 and the ranging device 12 are arranged in such a manner that the x direction of the pixel array is parallel to the baseline direction is also possible. In this case, the correction unit 87B corrects the x coordinate in the spatial coordinates (x coordinate and y coordinate) of the sample point (multipixel) on the basis of the distance information of the depth image supplied from the distance operation unit 86.

### 12. Fourth Embodiment of Ranging System

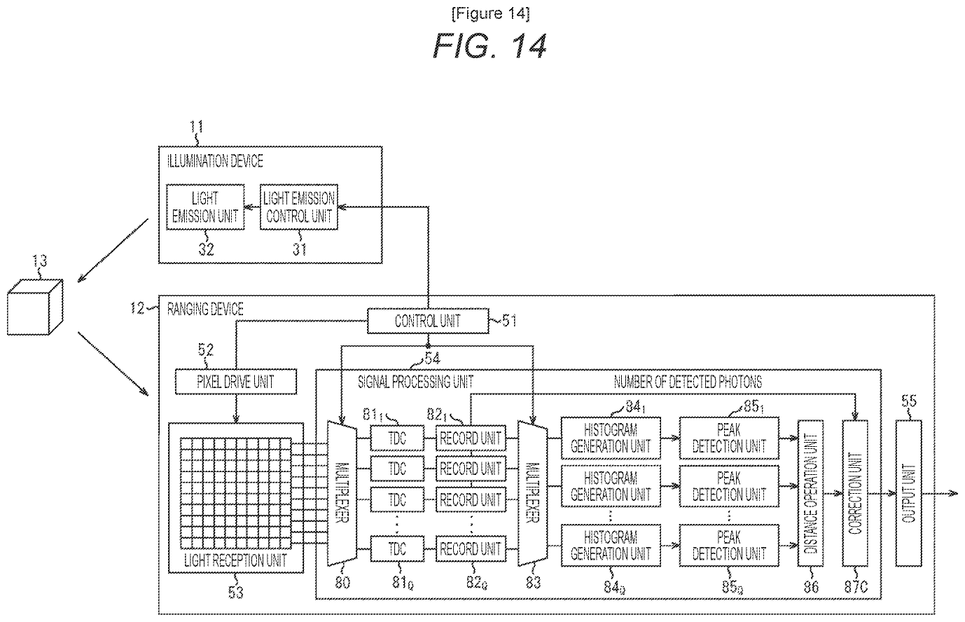

FIG. 14 is a block diagram illustrating a detailed configuration example of a fourth embodiment of the ranging system 1.

In FIG. 14 also, parts corresponding to those of the first embodiment explained in FIG. 5 are denoted by the same reference numerals, description of the parts is omitted as appropriate, and it is described focusing on different parts.

In the fourth embodiment in FIG. 14, the correction unit 87 of the first embodiment illustrated in FIG. 5 is replaced with a correction unit 87C. Other configurations of the ranging system 1 are similar to those of the first embodiment.

The correction unit 87C according to the fourth embodiment performs both the correction processing of the spatial coordinates of the multipixel based on the number of detected photons executed by the correction unit 87 in the first embodiment, and the correction processing of the spatial coordinates of the multipixel based on the distance information executed by the correction unit 87B in the third embodiment.

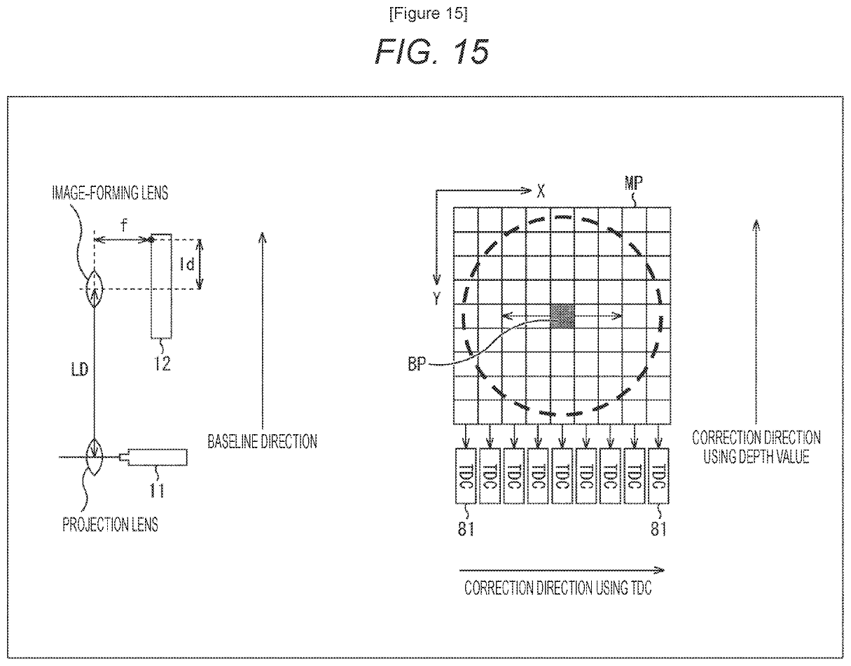

Here, the illumination device 11 and the ranging device 12, and the TDC 81 in the ranging device 12 are arranged as illustrated in FIG. 15.

The illumination device 11 and the ranging device 12 are arranged in such a manner that the y direction of the pixel array is parallel to the baseline direction. Furthermore, the TDC 81 is arranged in the y direction of the pixel array in such a manner that the pixel signals of the respective pixels arrayed in the same column of the pixel array are output to the same TDC 81.

In a case where the TDC 81 is arranged in such a manner that the pixel signals of the respective pixels arrayed in the same column of the pixel array are output to the same TDC 81, as explained in A of FIG. 8, the x coordinate corresponding to the column of the pixel array can be corrected by the correction processing. That is, a correction direction using the TDC 81 is the x direction.

In contrast, in a case where the illumination device 11 and the ranging device 12 are arranged in such a manner that the y direction of the pixel array is parallel to the baseline direction, as explained in FIG. 12, the y coordinate corresponding to the row of the pixel array can be corrected by the correction processing. That is, the correction direction using the depth value is the y direction.

In this manner, by setting a sharing direction (y direction) of the TDC 81 to be parallel to the baseline direction of the illumination device 11 and the ranging device 12, the correction direction (x direction) of the spatial coordinates corrected on the basis of the number of detected photons and the correction direction (y direction) of the spatial coordinates corrected on the basis of the distance information are orthogonal to each other.

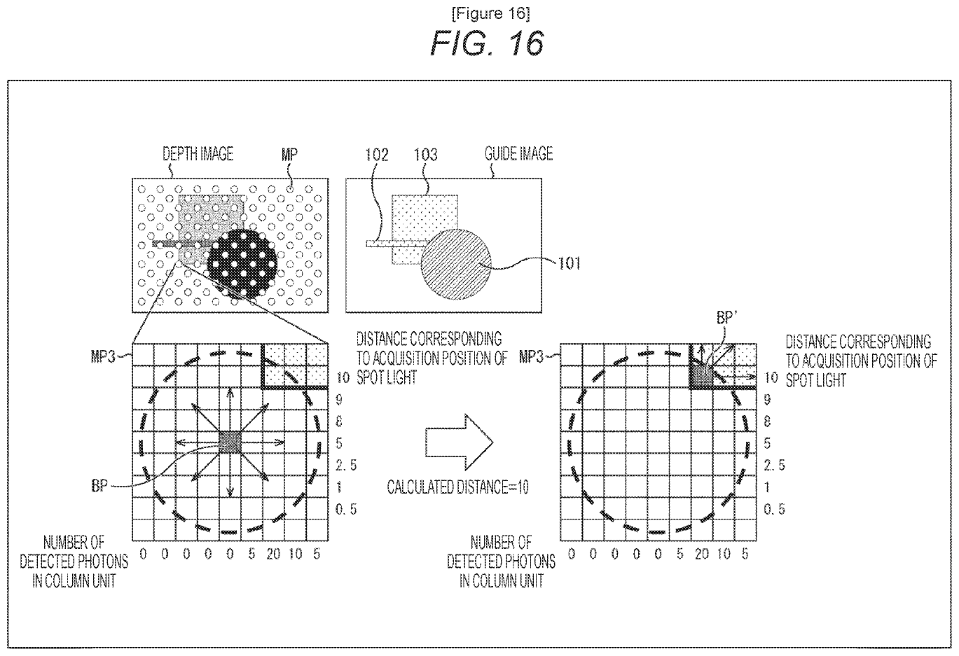

FIG. 16 illustrates an example of the correction processing of the spatial coordinates of the multipixel by the correction unit 87C.

The guide image and the depth image illustrated in FIG. 16 are similar to those in FIG. 6, so that the description thereof is omitted.

It is described focusing on a predetermined multipixel MP3 in the depth image. The multipixel MP3 includes 81 (nine by nine) pixels. In the multipixel MP3, a thick line in the vicinity of an upper right side corresponds to a boundary of the object 103.

The distance information calculated for the multipixel MP3 is supplied from the distance operation unit 86 to the correction unit 87C. The representative position of the distance information at that time is a center position BP of the multipixel MP3 set as the initial position. Here, suppose that the distance calculated by the distance operation unit 86 for the multipixel MP3 and supplied is 10 m.

The correction unit 87C corrects the representative position of the multipixel MP3 from the position BP to a position BP′.

Specifically, the correction unit 87C corrects the x coordinate of the representative position of the multipixel MP3 to a position of a third column from the right of the multipixel MP3, which is the column having the maximum number of (20) detected photons, on the basis of the number of detected photons in units of columns of the multipixel MP3.

Furthermore, the correction unit 87C corrects the y coordinate of the representative position of the multipixel MP3 to a position of a second row from the top of the multipixel MP3 corresponding to a case where the distance is 10 m on the basis of the distance information of the multipixel MP3.

As described above, the correction unit 87C may correct in the direction parallel to the baseline direction on the basis of the depth value and correct in the direction orthogonal to the baseline direction on the basis of the number of detected photons (luminance value), so that this may efficiently perform the correction processing of the spatial coordinates of the multipixel for the x coordinate and the y coordinate.

### 13. Flowchart of Fourth Ranging Processing

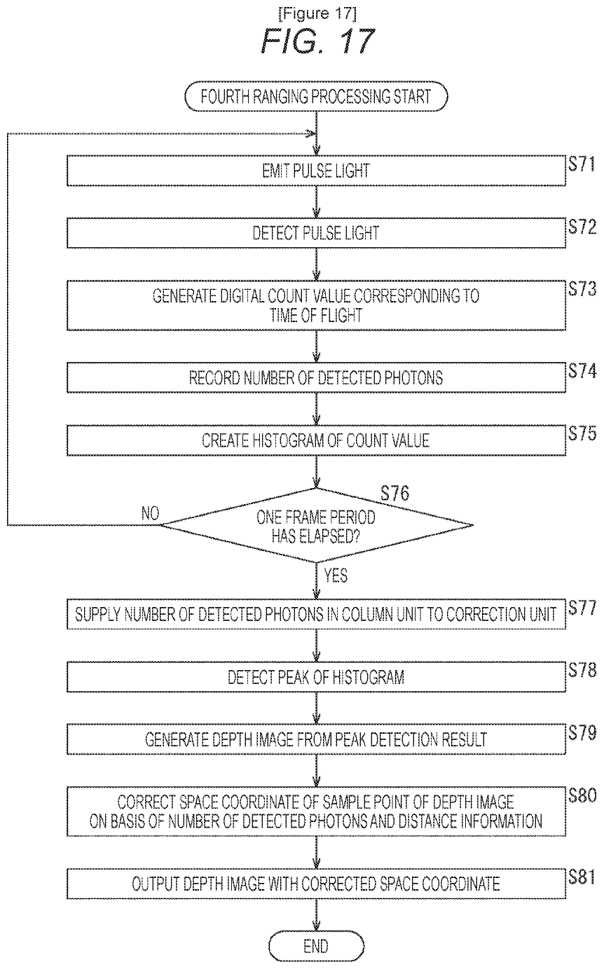

Next, ranging processing (fourth ranging processing) by the fourth embodiment of the ranging system 1 will be described with reference to a flowchart in FIG. 17. This processing is started when there is an instruction by the higher-level host device and the like to start the measurement, for example.

The processing at steps S71 to S79 is similar to the processing at steps S11 to S19 of the first ranging processing in FIG. 7, so that the description thereof will be omitted. That is, each record unit 82 supplies the number of detected photons to the correction unit 87B, and the depth image is generated from the peak detection result of the histogram to be supplied to the distance operation unit 86.

At step S80, the correction unit 87C of the ranging device 12 corrects the spatial coordinates of the sample point (multipixel) of the depth image on the basis of the number of detected photons from each record unit 82 and the distance information from the distance operation unit 86. Specifically, as described above, the x coordinate of the representative position of the multipixel is corrected on the basis of the number of detected photons, and the y coordinate of the representative position is corrected on the basis of the distance information of the depth image.

At step S81, the correction unit 87C outputs the depth image with the spatial coordinates after the correction. The depth image output from the correction unit 87C is output from the output unit 55 to an external device, and the fourth ranging processing is finished.

According to the fourth ranging processing described above, it is possible to correct the spatial coordinates of the multipixel, which is the sample point, using the number of detected photons and the distance information. Therefore, the acquisition coordinate position of the subject the distance information of which is acquired can be output with higher accuracy. Specification of the subject coordinates is important in a subsequent application that densifies an acquired signal (distance information) and the like. Since the acquisition coordinate position of the distance information can be output with higher accuracy, efficient densification and resolution enhancement of sparse acquired signals can be implemented in the subsequent application.

### 14. Conclusion

According to the ranging system 1 according to the first to fourth embodiments described above, it is possible to correct the spatial coordinates of the multipixel as the sample point using at least one of the number of detected photons or the distance information detected by the ranging device 12. It is possible to use only one or both of the number of detected photons and the distance information. In a case where both the number of detected photons and the distance information are used, by setting the sharing direction of the TDC 81 to be parallel to the baseline direction connecting the illumination device 11 and the ranging device 12, the correction processing of the spatial coordinates of the multipixel can be simultaneously performed for the x coordinate and the y coordinate.

The correction processing of the spatial coordinates of the multipixel can be performed with resolution of subpixel, and the acquisition coordinate position of the distance information can be output with higher spatial resolution and higher accuracy.

The ranging system 1 may be configured to be able to perform only one of the first to fourth embodiments described above, or may be configured to be able to selectively perform all of the first to fourth embodiments.

Note that, in the present specification, a system means a set of a plurality of components (devices, modules (parts) and the like), and it does not matter whether or not all the components are in the same housing. Therefore, a plurality of devices housed in separate housings and connected via a network and one device in which a plurality of modules is housed in one housing are both systems.

Furthermore, the embodiments of the present technology are not limited to the above-described embodiments and various modifications may be made without departing from the gist of the present technology.

Note that, the effects described in the present specification are merely examples and are not limited, and there may be effects other than those described in the present specification.

Note that, the present technology can have the following configurations.
(1)
A ranging device including:
a pixel array in which pixels are arranged in a matrix;
a record unit that records the number of detected photons for each division unit obtained by dividing a sample point including a plurality of the pixels into predetermined division units; and
a correction unit that corrects a representative position of spatial coordinates of distance information of the sample point on the basis of the number of detected photons for each of a plurality of the division units.
(2)
The ranging device according to (1) above, in which
the division unit is a column or a row of the pixel array.
(3)
The ranging device according to (1) or (2) above, in which
the correction unit corrects the representative position to a position of the division unit having the largest number of detected photons among the plurality of the division units that forms the sample point.
(4)
The ranging device according to (1) or (2) above, in which
the correction unit corrects the representative position to a weighted mean position weighted by the number of detected photons of the plurality of the division units that forms the sample point.
(5)
The ranging device according to (1) or (2) above, in which
the correction unit approximates the number of detected photons of the plurality of the division units that forms the sample point with a predetermined approximation function, and corrects the representative position to a position at which the number of detected photons is the largest in the approximation function.
(6)
The ranging device according to (1) or (2) above, in which
the correction unit corrects the representative position to a position at which the number of detected photons is the largest using a mean shift procedure on the number of detected photons of the plurality of the division units that forms the sample point.
(7) The ranging device according to any one of (1) to (6) above, in which
the correction unit corrects the representative position to a position obtained by adding a predetermined offset amount to a position determined on the basis of the number of detected photons of the division unit.
(8)
The ranging device according to any one of (1) to (7) above, further including:
a distance operation unit that performs an arithmetic operation of distance information of the sample point on the basis of a time of flight of pulse light detected at the sample point, in which
the correction unit also corrects the distance information of the sample point.
(9)
The ranging device according to (8) above, in which
the correction unit corrects the distance information of the sample point using a distance calculated on the basis of a light receiving position of the pulse light in a plurality of pixels that forms the sample point.
(10)
The ranging device according to (1) above, in which
the correction unit corrects the representative position of the spatial coordinates of the distance information of the sample point using a luminance value of an image imaged by an external sensor in place of the number of detected photons of each of the plurality of the division units.
(11)
The ranging device according to any one of (1) to (10) above, in which
the correction unit corrects the representative position of the spatial coordinates of the distance information of the sample point using the number of detected photons of each of the plurality of the division units and a luminance value of an image imaged by an external sensor.
(12)
The ranging device according to any one of (1) to (11) above, in which
the correction unit corrects the representative position of the spatial coordinates of the distance information of the sample point using a value obtained by normalizing the number of detected photons of each of the plurality of the division units by a luminance value of an image imaged by an external sensor.
(13)
The ranging device according to any one of (1) to (12) above, further including:
a distance operation unit that performs an arithmetic operation of the distance information of the sample point on the basis of a time of flight of pulse light detected at the sample point, in which
the correction unit further corrects the representative position of the spatial coordinates of the distance information of the sample point on the basis of the distance information of the sample point.
(14)
The ranging device according to (13) described above, in which
the correction unit corrects a position in a direction parallel to a baseline direction that connects an illumination device that emits the pulse light and the ranging device of the pixel array.
(15)
The ranging device according to (13) or (14), in which
a correction direction of the spatial coordinates corrected on the basis of the number of detected photons of the division unit is orthogonal to a correction direction of the spatial coordinates corrected on the basis of the distance information of the sample point.
(16)
The ranging device according to any one of (13) to (15) above, further including:
a plurality of TDCs that generates a digital count value corresponding to the time of flight of the pulse light on the basis of a pixel signal output from the pixels, in which
a TDC is shared by a plurality of pixels in a direction parallel to a baseline direction that connects an illumination device that emits the pulse light and the ranging device.
(17)
A signal processing method of a ranging device, in which
a ranging device including a pixel array in which pixels are arranged in a matrix
records the number of detected photons for each division unit obtained by dividing a sample point including a plurality of the pixels into predetermined division units; and
corrects a representative position of spatial coordinates of distance information of the sample point on the basis of the number of detected photons for each of a plurality of the division units.
(18)
A ranging system including:
an illumination device that applies pulse light; and
a ranging device that receives reflected light, which is the pulse light reflected by an object, in which
the ranging device includes:
a pixel array in which pixels that receive the reflected light are arranged in a matrix;
a record unit that records the number of detected photons for each division unit obtained by dividing a sample point including a plurality of the pixels into predetermined division units; and
a correction unit that corrects a representative position of spatial coordinates of distance information of the sample point on the basis of the number of detected photons for each of a plurality of the division units.

### REFERENCE SIGNS LIST

1 Ranging system
11 Illumination device
12 Ranging device
13 Object
31 Light emission control unit
32 Light emission unit
51 Control unit
52 Pixel drive unit
53 Light reception unit
54 Signal processing unit
80 Multiplexer
81₁ to 81_{Q} TDC
82₁ to 82_{Q} Record unit
83 Multiplexer
84₁ to 84_{Q} Histogram generation unit
85 Peak detection unit
86 Distance operation unit
87, 87A to 87C Correction unit
141 External sensor

1. A ranging device comprising:
a pixel array in which pixels are arranged in a matrix;
a record unit that records a number of detected photons for each division unit obtained by dividing a sample point including a plurality of the pixels into predetermined division units; and
a correction unit that corrects a representative position of spatial coordinates of distance information of the sample point on a basis of the number of detected photons for each of a plurality of the division units.

2. The ranging device according to claim 1, wherein
the division unit is a column or a row of the pixel array.

3. The ranging device according to claim 1, wherein
the correction unit corrects the representative position to a position of the division unit having a largest number of detected photons among the plurality of the division units that forms the sample point.

4. The ranging device according to claim 1, wherein
the correction unit corrects the representative position to a weighted mean position weighted by the number of detected photons of the plurality of the division units that forms the sample point.

5. The ranging device according to claim 1, wherein
the correction unit approximates the number of detected photons of the plurality of the division units that forms the sample point with a predetermined approximation function, and corrects the representative position to a position at which the number of detected photons is largest in the approximation function.

6. The ranging device according to claim 1, wherein
the correction unit corrects the representative position to a position at which the number of detected photons is largest using a mean shift procedure on the number of detected photons of the plurality of the division units that forms the sample point.

7. The ranging device according to claim 1, wherein
the correction unit corrects the representative position to a position obtained by adding a predetermined offset amount to a position determined on a basis of the number of detected photons of the division unit.

8. The ranging device according to claim 1, further comprising:
a distance operation unit that performs an arithmetic operation of distance information of the sample point on a basis of a time of flight of pulse light detected at the sample point, wherein
the correction unit also corrects the distance information of the sample point.

9. The ranging device according to claim 8, wherein
the correction unit corrects the distance information of the sample point using a distance calculated on a basis of a light receiving position of the pulse light in a plurality of pixels that forms the sample point.

10. The ranging device according to claim 1, wherein
the correction unit corrects the representative position of the spatial coordinates of the distance information of the sample point using a luminance value of an image imaged by an external sensor in place of the number of detected photons of each of the plurality of the division units.

11. The ranging device according to claim 1, wherein
the correction unit corrects the representative position of the spatial coordinates of the distance information of the sample point using the number of detected photons of each of the plurality of the division units and a luminance value of an image imaged by an external sensor.

12. The ranging device according to claim 1, wherein
the correction unit corrects the representative position of the spatial coordinates of the distance information of the sample point using a value obtained by normalizing the number of detected photons of each of the plurality of the division units by a luminance value of an image imaged by an external sensor.

13. The ranging device according to claim 1, further comprising:
a distance operation unit that performs an arithmetic operation of the distance information of the sample point on a basis of a time of flight of pulse light detected at the sample point, wherein
the correction unit further corrects the representative position of the spatial coordinates of the distance information of the sample point on a basis of the distance information of the sample point.

14. The ranging device according to claim 13, wherein
the correction unit corrects a position in a direction parallel to a baseline direction that connects an illumination device that emits the pulse light and the ranging device of the pixel array.

15. The ranging device according to claim 13, wherein
a correction direction of the spatial coordinates corrected on a basis of the number of detected photons of the division unit is orthogonal to a correction direction of the spatial coordinates corrected on a basis of the distance information of the sample point.

16. The ranging device according to claim 13, further comprising:
a plurality of TDCs that generates a digital count value corresponding to the time of flight of the pulse light on a basis of a pixel signal output from the pixels, wherein
a TDC is shared by a plurality of pixels in a direction parallel to a baseline direction that connects an illumination device that emits the pulse light and the ranging device.

17. A signal processing method of a ranging device, wherein
a ranging device including a pixel array in which pixels are arranged in a matrix
records a number of detected photons for each division unit obtained by dividing a sample point including a plurality of the pixels into predetermined division units; and
corrects a representative position of spatial coordinates of distance information of the sample point on a basis of the number of detected photons for each of a plurality of the division units.

18. A ranging system comprising:
an illumination device that applies pulse light; and
a ranging device that receives reflected light, which is the pulse light reflected by an object, wherein
the ranging device includes:
a pixel array in which pixels that receive the reflected light are arranged in a matrix;
a record unit that records a number of detected photons for each division unit obtained by dividing a sample point including a plurality of the pixels into predetermined division units; and
a correction unit that corrects a representative position of spatial coordinates of distance information of the sample point on a basis of the number of detected photons for each of a plurality of the division units.
